(19) United States
(12) Patent Application Publication
(10) Pub. No.: US 2023/0198566 A1
(43) Pub. Date: Jun. 22, 2023

(54) PORTABLE ELECTRONIC OBJECT

(71) Applicant: ETA SA Manufacture Horlogère Suisse, Grenchen (CH)

(72) Inventor: Xavier STEHLIN, Cudrefin (CH)

(73) Assignee: ETA SA Manufacture Horlogère Suisse, Grenchen (CH)

(21) Appl. No.: 17/986,450

(22) Filed: Nov. 14, 2022

(30) Foreign Application Priority Data
Dec. 17, 2021 (EP) 21215666.5

(51) Int. Cl. H04B 1/3827; G04G 17/04; G04G 21/08; H01Q 1/27

(52) U.S. Cl. CPC H04B 1/385; G04G 17/04; G04G 21/08; H01Q 1/273; H01Q 1/2291

(57) ABSTRACT

A portable electronic object (1) including a case (3) provided with an external part element (2) entirely or partially forming a tactile interface of said electronic object (1), the external part element including a hollow body containing a substrate (5) over which are formed an antenna circuit (10) of a communication module (6) of the object (1) and a tactile control circuit (13) of a tactile control member (8) of this object (1).

### CROSS REFERENCE TO RELATED APPLICATIONS

This application is claiming priority based on European Patent Application No. 21215666.5 filed on Dec. 17, 2021, the disclosure of which is incorporated herein in its entirely by reference.

### TECHNICAL FIELD OF THE INVENTION

The invention relates to a portable electronic object comprising an external part element entirely or partially forming a tactile interface and including an antenna circuit of a communication module of said object.

### TECHNOLOGICAL BACKGROUND

Many portable electronic objects that could connect to communication networks are known in the prior art such as electronic watches which are provided with tactile interfaces conventionally arranged in the crystals of these. In general, such tactile interfaces are used to improve the interactivity of the watches and to simplify manipulations thereof in particular when these offer a large number of menus and functions.

In order to be able to connect to communication networks such as Bluetooth-type or geolocation-related networks, such electronic objects comprise communication means conventionally integrating an antenna. It is known that the optimum size of such an antenna depends directly on the wavelength of the emitted/received signal. Indeed, an antenna with an optimum length allows sending/receiving a signal in its entirety and at full power.

In electronic objects such as watches, the available space being limited, an antenna should have a suitable design in order to be integrated in the case of the watch. And if the watch integrates a radio communication means which operates over radio frequencies (such as 2.4 GHz or 1.5 GHz), the size of the product becomes critical with regards to the wavelength (120 mm and 200 mm).

Moreover, other constraints should also be taken into account because electronic objects such as watches include many metallic portions and because an antenna should be isolated therefrom.

In this context, one can understand that there is a need to find a solution, in particular one that does not have the drawbacks of the prior art.

### SUMMARY OF THE INVENTION

One of the aims of the invention is to provide a portable electronic object such as a watch, comprising a tactile interface and integrating an antenna circuit having an optimum length to send/receive a signal in its entirety and at full power and intended to be fitted into the case of this watch whose receiving volume is limited.

Another aim of the invention is to obtain a portable electronic object whose aesthetics, energy consumption and manufacturing costs are not affected or barely affected by the integration of a tactile interface and of an antenna circuit into an external part element of this object.

For this purpose, the invention relates to a portable electronic object comprising a case provided with an external part element entirely or partially forming a tactile interface of said electronic object, said external part element including a hollow body containing a substrate over which are formed an antenna circuit of a communication module of said object and a tactile control circuit of a tactile control member of this object.

In other embodiments:
the substrate comprises a main portion and first and second connecting portions each intended to be folded with respect to this main portion;
the substrate comprises an upper face over which the antenna circuit and the tactile control circuit are formed;
the antenna circuit comprise first and second strands formed over a first portion of the upper face comprised within the main portion of the substrate, each of said first and second strands having a proximal end and a distal end, and extending in parallel between their proximal and distal ends, the first and second strands being connected by their distal ends as well as at their proximal ends;
the tactile control circuit comprises at least one electrode formed over a second portion of the upper face comprised within the main portion of the substrate, said electrode being formed by a layer of at least one conductive material applied over said upper face;
the upper face of the main portion of this substrate is preferably positioned within a hatch defined in the hollow body of the external part element opposite a wall of this hatch which forms an outer face of this external part element;
the substrate is made of flexible plastic;
the antenna circuit comprises a microcircuit connected to the first and second strands via a connecting track formed over the upper face of the substrate;
the control circuit comprises a microcontroller connected to said at least one electrode via at least one connecting track formed over the upper face of the substrate;
the external part element is manufactured in at least one dielectric and/or electrically non-conductive material;
the object is a watch in particular a smartwatch comprising the external part element which is a bezel provided with the hatch within which said substrate is arranged;
the communication module is configured to communicate according to a Bluetooth-type protocol.

### BRIEF DESCRIPTION OF THE FIGURES

Other features and advantages of the present invention will appear more clearly from the following detailed description, made with reference to the appended figures listed hereinbelow:

FIG. 1 is a schematic representation of a portable electronic object comprising an external part element entirely or partially forming a tactile interface of said object according to an embodiment of the invention;

FIG. 2 is a representation of a substrate that can be comprised within a hatch of the external part element, said substrate including an antenna circuit of a communication module of said object and a tactile control circuit of a tactile control member of this object according to the embodiment of the invention;

FIG. 3 is a representation of a variant of the substrate comprising the antenna circuit and the tactile control circuit, according to the embodiment of the invention, and

FIG. 4 represents a bezel forming the external part element comprising the substrate when the portable electronic object is an electronic watch according to the embodiment of the invention.

### DETAILED DESCRIPTION OF THE INVENTION

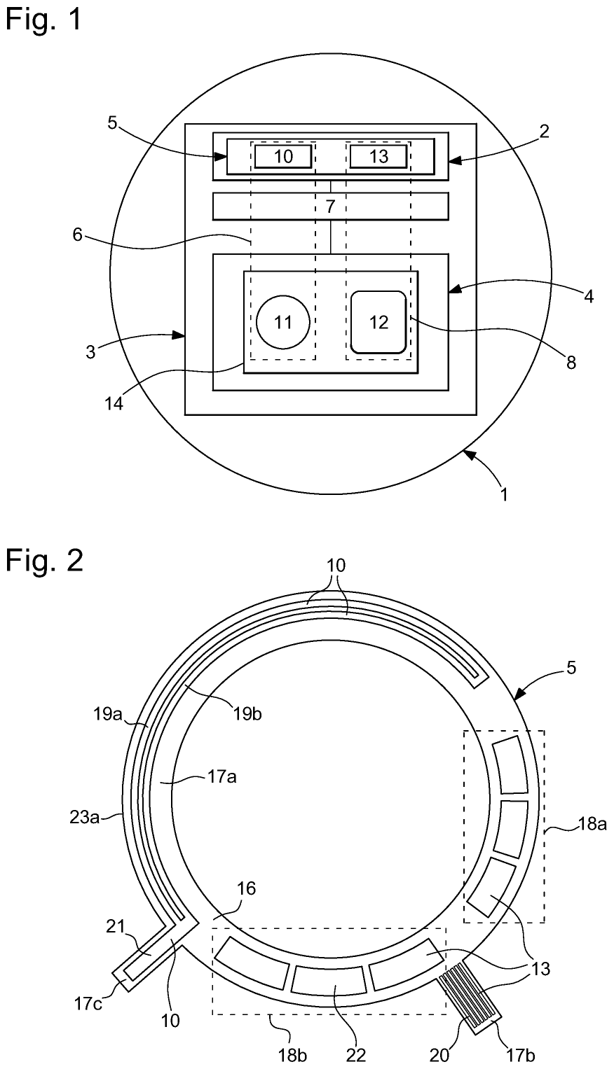

Referring to FIG. 1, the invention covers a portable electronic object 1 or else a portable electronic apparatus. In the present embodiment of this invention, such an electronic object 1 is preferably an electronic watch 1 such as a smartwatch. Alternatively, it should be noted that this electronic object 1 can also be a smartphone, a mobile GPS apparatus, a laptop, a tactile tablet, a sports watch, a fitness tracker, a heart-rate meter apparatus or a music player.

In this context, such a portable electronic object 1 is provided with a case 3 including an external part element 2 entirely or partially forming a tactile interface of said electronic object 1 through which a wearer of said object can interact with the latter. This case 3 also includes a middle which can be made of metal (for example of steel, preferably stainless steel), of a synthetic material (for example of a composite material comprising a polymer matrix reinforced with fibres, typically carbon fibres) or of ceramic or else of at least one dielectric and/or electrically non-conductive material. The case 3 also comprises a back and a crystal which contribute to form with the middle, a hatch of this case 3. In particular, a display device 7 and an electronic device 4 of said electronic object 1 are arranged within such a hatch.

The display device 7 includes display elements which can be analog such as hands and/or digital such as an LCD, LED or OLED screen. Such a display device 7 is located between the crystal and the electronic device 4, a spacer or flange can be arranged between the crystal and this display device 7.

As regards the electronic device 4, it is configured to provide at least one piece of information having to be displayed on this display device 7. Non-exhaustively and without limitation, this electronic device 4 includes a communication module 6, a control module of the portable electronic object 1, an electrical energy accumulator in particular a battery as well as different sensors such as sensors involved in the determination of a geolocation, an altitude or a temperature of a location or in the determination of biometric, vital and/or behavioural parameters of the wearer of the electronic object 1.

It should be noted that in this configuration, the control module enables the wearer of such an electronic object 1 to be able to interact with the latter in particular by being able to activate/deactivate/select different functions that can be implemented by this electronic object 1. This control module comprises a tactile control member 8 and in some alternatives other control members such as push-pieces or buttons arranged on the middle.

In the electronic device 4, the communication module 6 comprises an antenna circuit 10 connected to a microcircuit 11, and the tactile control member 8 comprises a microcontroller 12 connected to a tactile control circuit 13. As we will see later on, the antenna circuit 10 and the control circuit 13 are arranged over a substrate 5 comprised within the external part element 2, the latter entirely or partially forming a tactile interface of said electronic object 1.

Preferably, such an external part element 2 is fastened on the middle of the case 3. This external part element 2 may be a part removably fastened on the middle or else a part integrally made with this middle. It may consist of a monolithic part or conversely of a part made into two portions connected together in a reversible and/or tight manner. The external part element 2 comprises a hollow body including a hatch within which the substrate 5 provided with the antenna circuit 10 and with the tactile control circuit 13 is located. For this antenna circuit 10 and this control circuit 13 to operate effectively and/or optimally, this external part element 2 is made of at least one dielectric and/or electrically non-conductive material. Said at least one material allows contributing to the achievement of the capacitive effect of the tactile control member 8. This material is also involved in not deteriorating the radiation of the antenna circuit 10, enlarging its electric length and improving its efficiency with regards to its physical size. For example, such a material may be a polymer, titanium or a ceramic, or any other synthetic material. It should be noted that it is possible that the entire body of this external part element 2 is not made of this material type but only portions of this body within which are arranged the antenna circuit 10 and the control circuit 13 are made of this material.

In the case where the portable electronic object 1 is an electronic watch, the external part element 2 may be a bezel visible in FIG. 4. Such a bezel 2 is then located at the middle and clasps the crystal. It may consist of a rotating bezel or a fixed bezel. The bezel 2 may also be arranged in the case 3 so as to form one-piece with the middle i.e. a middle-bezel. The middle and the bezel 2 have an outer face which is the face visible to the wearer of this watch. The bezel 2 may comprise a graduation over its outer face. In the illustrated example, the graduation comprises figurative indexes 24 which are in the form of numerals (preferably Arabic numerals). One can further notice that in such a context the electronic device 4 is for example an electronic horological movement.

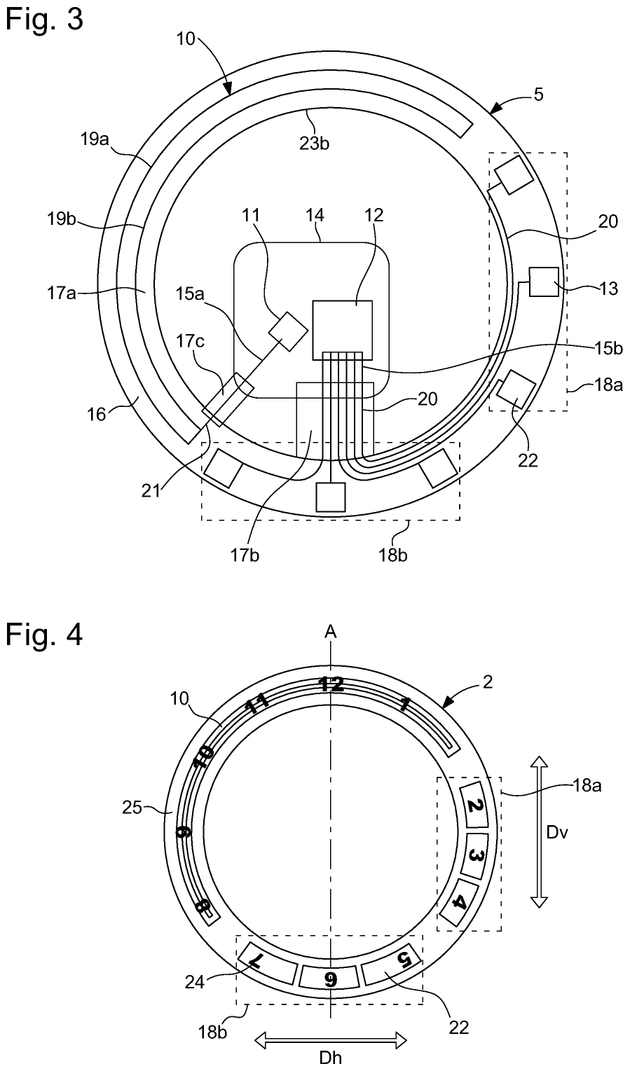

Referring to FIGS. 2 to 4, the substrate 5 comprised within this external part element 2 is advantageously made in the form of a flexible printed circuit (commonly called “flex”). Preferably, such a substrate 5 also called “support” or “plate” is manufactured in a high-performance flexible plastic material. This plastic material may be a polymer such as polyimide known as Kapton™ or a polyester. This substrate 5 comprises a main portion 17a having a substantially circular shape and first and second connecting portions 17b, 17c defined over an external edge 23a (visible in FIG. 2) or over an internal edge 23b (visible in FIG. 3) of the main portion 17a of the substrate 5 while extending radially from this said edge 23a, 23b. These first and second connecting portions 17b, 17c are in the form of an excrescence of the substrate 5. Such a substrate 5 comprises upper 16 and lower faces which are planar and parallel to each other. The shape of the main portion 17a of the substrate 5 is similar or substantially similar to that of the hatch of the bezel 2 within which the substrate 5 is intended to be positioned. In this configuration, the upper face 16 of the main portion 17a of this substrate 5 is preferably arranged within this hatch opposite a wall of this hatch which constitutes/forms an outer face of this external part element 2. As regards the first and second connecting portions 17b, 17c, each is intended to be folded with respect to the upper face 16 in order to be connected respectively to the microcontroller 12 of the control member 8 and to the microcircuit 11 of the communication module 6. To this end, the external part element 2 may comprise openings providing access to a printed circuit 14 of the electronic device 4 including the microcontroller 12 of the control member 8 and the microcircuit 11 of the communication module 6. Such openings formed in the body of this external part element 2 can be crossed by these first and second portions 17b, 17c.

Referring to FIGS. 2 and 3, the control member 8 comprises the microcontroller 12 which is connected to the tactile control circuit 13. Such a tactile control circuit 13 comprises electrodes 22 deposited over the main portion 17a of the substrate 5 comprised within the external part element 2. Each electrode 22 may be in the form of a layer of conductive materials forming a connecting point. Such an electrode 22 has a circular or parallelepiped or triangular shape. In this configuration, the control circuit 13 also comprises at least one connecting track 20 comprised over the upper face 16 of the substrate 5. This said at least one connecting track 20 is able to cooperate with at least one electrical track 15b of the printed circuit 14 of the electronic device 4 comprising the microcontroller 12. In this manner, each electrode 22 is thus connected to the microcontroller 12 from this said at least one connecting track 20 and said at least one electrical track 15b. Thus, said at least one connecting track 20 is comprised over the upper face 16 of the substrate 5 while extending from the electrode 22 up to the free end of the first connecting portion 17b. Finally, one can notice that the tactile control circuit 13 preferably comprises as many connecting tracks 20 as electrodes 22 that the main portion 17a includes.

In the present embodiment visible in FIGS. 2 to 4 wherein the object 1 is an electronic watch, the tactile control member 8 comprises six electrodes 22 distributed over the upper face 16 of the main portion 17a of the substrate 5. More specifically, these electrodes 22 are applied/deposited over this upper face 16 of the substrate 5 so as to define/form two distinct tactile areas 18a, 18b over the outer face 25 of the bezel 2, these two tactile areas 18a, 18b forming the tactile interface of said electronic object 1. The first tactile area 18a comprises three electrodes 22 respectively arranged beneath the indexes 24 two, three and four defined over the outer face 25 of the bezel 2. The second tactile area 18b also comprises three electrodes 22 respectively arranged beneath the indexes 24 five, six and seven defined over this outer face 25 of the bezel 2. In this configuration, the first tactile area 18a enables the wearer of the watch to interact with the latter by performing a movement in particular a “vertical movement” (referenced Dv in FIG. 4) of an accessory such as a stylus or a tip of one of his limbs such as a finger over this first area 18a. As regards the second tactile area 18b, it enables the wearer of the watch to interact with the latter by performing a movement in particular a “horizontal movement” (reference Dh in FIG. 4) of such an accessory or of the tip of one of his limbs over this area 18b. The vertical movement describes a trajectory which is substantially parallel or parallel to an axis of symmetry A of the bezel 2 and the horizontal movement describes a trajectory which, in turn, is substantially perpendicular or perpendicular to this axis A or to the trajectory described by the vertical movement. Such an axis A separates the bezel 2 into two equal portions while connecting the indexes 24 twelve and six present over the outer face 25 of this bezel 2.

In the electronic device 4, the communication module 6 is able to enable the connection of the portable electronic object 1 to a Bluetooth-type communication network. In other words, the communication module 6 is configured to communicate according to a Bluetooth-type protocol. Alternatively, this communication module 6 can be able to enable the connection of the portable electronic object 1 to a GNSS (Geolocation and Navigation Satellite System) satellite location network, such as the GPS (Global Positioning System), Glonass or Galileo. This communication module 6 comprises the antenna circuit 10 connected to the microcircuit 11. Such an antenna circuit 10 is comprised over the upper face 16 of the substrate 5. This antenna circuit 10 comprises first and second strands 19a, 19b each having a proximal end and a distal end, and extending in parallel between their proximal and distal ends. In this antenna circuit 10, the architecture with two strands in parallel allows enlarging the frequency band (100 MHz), necessary for example to communicate over a Bluetooth-type communication network (2.4 GHz). In this antenna circuit 10, the first and second strands 19a, 19b are connected by their distal ends as well as at their proximal ends. In this configuration, the antenna circuit 10 extends essentially according to a circular arc trajectory including two strands 19a, 19b arranged in parallel over the substrate 5 which follows this trajectory. This antenna circuit 10 also comprises a connecting track 21 connected to these proximal ends which is comprised over the upper face 16 of the substrate 5. This connecting track 21 is able to cooperate with at least one electrical track 15a of the printed circuit 14 of the electronic device 4 comprising the microcircuit 11 of the communication module 6. In this manner, the antenna circuit 10 is connected to this microcircuit 11 from this said at least one connecting track 21 and from said at least one electrical track 15a. Furthermore, this connecting track 21 is comprised over the upper face 16 of the substrate 5 while extending from the proximal ends of the first and second strands 19a, 19b up to the free end of the second connecting portion 17c of the substrate 5.

As we have seen, the antenna circuit 10 and the tactile control circuit 13 are entirely or partially formed over distinct portions of the upper face 16 of the main portion 17a of the substrate 5. More specifically, this upper face 16 of the main portion 17a comprises two portions having substantially the same surface area or the same surface area. This first portion comprises the first and second strands 19a, 19b as well as a portion of the connecting track 21 of the antenna circuit 10. In turn, the second portion comprises the electrodes 22 and a portion of the connecting tracks 20 of the control circuit 13.

It should be further noted that the control circuit 13 and the antenna circuit 10 can be screen-printed with silver over the substrate 5 made of polyester or can be screen-printed with copper over a substrate 5 made of polyimide.

It goes without saying that the present invention is not limited to the embodiment that has just been described and that various simple modifications and variants can be considered by a person skilled in the art without departing from the scope of the invention as defined by the appended claims.

1. A portable electronic object (1) comprising a case (3) provided with an external part element (2) entirely or partially forming a tactile interface of said electronic object (1), said external part element including a hollow body containing a substrate (5) over which are formed an antenna circuit (10) of a communication module (6) of said object (1) and a tactile control circuit (13) of a tactile control member (8) of this object (1).

2. The object (1) according to claim 1, wherein the substrate (5) comprises a main portion (17a) and first and second connecting portions (17b, 17c) each intended to be folded with respect to this main portion (17a).

3. The object (1) according to claim 1, wherein the substrate (5) comprises an upper face (16) over which the antenna circuit (10) and the tactile control circuit (13) are formed.

4. The object (1) according to claim 1, wherein the substrate (5) comprises an upper face (16) over which the antenna circuit (10) and the tactile control circuit (13) are formed, this antenna circuit (10) comprise first and second strands (19a, 19b) formed over a first portion of the upper face (16) comprised within the main portion (17a) of the substrate (5), each of said first and second strands (19a, 19b) having a proximal end and a distal end, and extending in parallel between their proximal and distal ends, the first and second strands (19a, 19b) being connected by their distal ends as well as at their proximal ends.

5. The object (1) according to claim 1, wherein the substrate (5) comprises a main portion (17a) and first and second connecting portions (17b, 17c) each intended to be folded with respect to this main portion (17a), the tactile control circuit (13) comprises at least one electrode (22) formed over a second portion of the upper face (16) comprised within the main portion (17a) of the substrate (5), said electrode (22) being formed by a layer of at least one conductive material applied over said upper face (16).

6. The object (1) according to claim 1, wherein the substrate (5) comprises a main portion (17a) and first and second connecting portions (17b, 17c) each intended to be folded with respect to this main portion (17a), the upper face (16) of the main portion (17a) of this substrate (5) is positioned within a hatch defined in the hollow body of the external part element (2) opposite a wall of this hatch which forms an outer face of this external part element (2).

7. The object (1) according to claim 1, wherein a main portion (17a) and first and second connecting portions (17b, 17c) each intended to be folded with respect to this main portion (17a), the upper face (16) of the main portion (17a) of this substrate (5) is positioned within a hatch defined in the hollow body of the external part element (2) opposite a wall of this hatch which forms an outer face of this external part element (2), the substrate (5) is made of flexible plastic.

8. The object (1) according to claim 1, wherein the substrate (5) comprises an upper face (16) over which the antenna circuit (10) and the tactile control circuit (13) are formed, this antenna circuit (10) comprise first and second strands (19a, 19b) formed over a first portion of the upper face (16) comprised within the main portion (17a) of the substrate (5), each of said first and second strands (19a, 19b) having a proximal end and a distal end, and extending in parallel between their proximal and distal ends, the first and second strands (19a, 19b) being connected by their distal ends as well as at their proximal ends, the antenna circuit (10) comprises a microcircuit (11) connected to the first and second strands (19a, 19b) via a connecting track (21) formed over the upper face (16) of the substrate (5).

9. The object (1) according to claim 1, wherein the substrate (5) comprises an upper face (16) over which the antenna circuit (10) and the tactile control circuit (13) are formed, this antenna circuit (10) comprise first and second strands (19a, 19b) formed over a first portion of the upper face (16) comprised within the main portion (17a) of the substrate (5), each of said first and second strands (19a, 19b) having a proximal end and a distal end, and extending in parallel between their proximal and distal ends, the first and second strands (19a, 19b) being connected by their distal ends as well as at their proximal ends, the control circuit (13) comprises a microcontroller (12) connected to said at least one electrode (22) via at least one connecting track (20) formed over the upper face (16) of the substrate (5).

10. The object (1) according to claim 1, wherein the external part element (2) is manufactured in at least one dielectric and/or electrically non-conductive material.

11. The object (1) according to claim 1, wherein the object is a smartwatch comprising the external part element (2) which is a bezel provided with the hatch within which said substrate (5) is arranged.

12. The object (1) according to claim 1, wherein the communication module (6) is configured to communicate according to a Bluetooth-type protocol.
